(19) United States
(12) Patent Application Publication
(10) Pub. No.: US 2012/0058238 A1
(43) Pub. Date: Mar. 8, 2012

(54) METHOD FOR FLAVOR-TREATING FOODSTUFFS PROVIDED IN A PACKAGING

(76) Inventor: Alexander Mittermayr, Leonding (AT)

(21) Appl. No.: 13/320,112

(22) PCT Filed: Mar. 5, 2010
(86) PCT No.: PCT/AT10/00066

§ 371 Date: Nov. 11, 2011

(30) Foreign Application Priority Data
May 20, 2009 (AT) A 791/2009

(51) Int. Cl. A23L 1/226; A47J 43/00; A23L 1/48

(52) U.S. Cl. 426/561; 99/534

(57) ABSTRACT

A method is disclosed for flavor-treating a food product (3) provided in a packaging (1), in which a protective gas (5), especially carbon dioxide, nitrogen, inert gas or mixtures thereof, is introduced into the head space (4) of the open packaging (1) together with a fluid (7) comprising at least one flavoring agent before the packaging (1) is sealed in a gas-tight manner. In order to provide improved conditions for the method it is proposed to add an antioxidant to the fluid (7), which in particular comprises water as the main constituent.

### FIELD OF THE INVENTION

The invention relates to a method for flavor-treating foodstuffs provided in a packaging, wherein a protective gas, especially carbon dioxide, nitrogen, inert gas or mixtures thereof, is introduced into the head space of the open packaging together with a fluid comprising at least one flavoring agent before the packaging is sealed in a gas-tight manner.

### DESCRIPTION OF THE PRIOR ART

In order to enable predetermining a scent on opening a foodstuff packaging, it is known from the state of the art (DE69500032T2, DE69616765T2) to introduce a food-compatible protective gas plus a flavoring agent into the head space of the packaging, with the flavoring agent being dissolved in an organic fluid, An inert gas such as carbon dioxide and/or nitrogen can be used as a protective gas, with said gases, in their capacity as a gas or gas mixture, jointly having the object of displacing the oxygen of the atmosphere in the head space the packaging. It is intended by the protective gas to improve the shelf life of the foodstuff and its scent on the one hand, and to support the natural scent of the foodstuff by the additional flavoring agent on the other hand. It has proven to be disadvantageous with increasing duration of the packaging that despite the protective gas and the flavoring agent it is not possible to prevent an adulteration of the scent, so that a scent that is predetermined upon opening and is kept within narrow limits cannot be created. An improved evacuation of the packaging before the introduction of the protective gas and/or an improved gas scavenging of the packaging with protective gas was able to reduce such an adulteration, but this entails a considerable amount of processing work and expenditure.

it is further known from WO2007/002768A2 to treat foodstuffs with a fluid comprising water, a flavoring agent and an antioxidant and to introduce the same thereafter into a packaging. This packaging can thereafter be provided with a modified atmosphere, e.g. with the help of a protective gas. The disadvantageous aspect is that such a method is laborious and moreover a constant flavor-treating of the head space of the packaging cannot be ensured. WO2007/002768A2 is therefore unable to exclude changes in the scent.

### SUMMARY OF THE INVENTION

The invention is therefore based on the object by starting out from the initially explained state of the art to improve a method for aroma treatment of a foodstuff packaging in such a way that despite long storage periods it is no longer necessary to accept any changes in the scent, or the scent can be kept within narrow limits upon opening. Moreover, the method shall be simple and cost-effective.

This object is achieved by the invention with respect to the method in such a way that an antioxidant is added to the fluid with the flavoring agent, which comprises water as the main constituent.

If a food-compatible antioxidant is added to the fluid with the flavoring agent and if the fluid comprises water as the main constituent, it was surprisingly noticed that the scent of the packaged foodstuff can be kept within a comparatively narrow limits. The antioxidant which is mixed with water or dissolved therein can be distributed together with the protective gas in an especially advantageous manner in the head space above the foodstuff, so that an even delivery of scent over the volume of the head space can be expected. In particular, the flavoring agent which is mixed in the water or dissolved therein can also be protected from adulteration by the antioxidant caused by a potential oxidation of the foodstuff if the flavoring agent reaches the foodstuff during the introduction by the fluid for example. An improved and more stable scent can therefore be obtained during the opening of the packaging than is known from the state of the art, even if there are comparatively long storage periods, through which the invention can be characterized in particular. An additional factor is that even process-induced deviations during the evacuation and/or gas scavenging and the degree of filling of protective gas have reduced effects on the scent during the opening of the packaging, leading to a lower effort in the process and thus to a more cost-effective method. Moreover, the main constituent of water has proven to be especially advantageous concerning simplified process conditions in flavoring treatment since the fluid can be introduced into the head space without having to consider the position of the foodstuff. No changes in the composition of the foodstuff need to be taken into account by the composition of the fluid. In contrast to the state of the art, it is not necessary to expect any adulteration of the scent and therefore negative effects on the purchase behavior of the consumers even in the case of a comparatively prolonged storage period. Especially an inert gas, carbon dioxide or nitrogen as a food-compatible protective gas has proven to be useful for extending the shelf life and for conserving the scent of foodstuff, with the inert gas being a noble gas or nitrogen or a mixture thereof. A flavoring agent as a foodstuff additive can be chosen according to the list of the European Commission. Moreover, a gas with a mixture of 20% CO₂ and 80% N₂ can be used for the protective gas or instead of the inert gas in order to enable the foodstuff packaging to be packed with a modified atmosphere. It can therefore occur that as a result of the joint introduction of fluid with a composition comprising water, a flavoring agent and antioxidants on the one hand and a protective gas on the other hand it is possible to provide especially simple and cost-effective process conditions with which the highest conditions for flavor-treating of a head space of a packaging can be fulfilled. It is understood that foodstuff can also be regarded as a food product.

Special conditions concerning freshness and consistency of the scent can be obtained when the fluid comprises a flavoring essence as the flavoring agent. Flavoring essences can ensure an especially natural scent on opening the foodstuff packaging in their capacity as concentrated or non-concentrated products, which may increase the acceptance of such a packaging by the consumer. Moreover, the use of a flavoring essence can also provide a method in that a scent can be maintained within narrow and predetermined limits even over prolonged storage periods.

Simple process conditions are obtained when the fluid is added to the protective gas with the help of a negative pressure. Moreover, advantageous distribution conditions of the fluid in the protective gas can be obtained, which can be produced for example by a swirling of the fluid caused by the negative pressure.

If the protective gas is sprayed together with the food-compatible fluid into the head space of the packaging, an improved distribution of the fluid in the head space for a more constant delivery of the scent can be obtained.

Special mixing conditions for flavor-treating are obtained when the quantities of the flavoring agent are in the range of 0.1 to 3% by weight and of the oxidant in the range of 0.1 to 10% by weight on the basis of the weight of fluid. The remaining percent by weight can be provided by water.

If the fluid is atomized into an aerosol before it is introduced into the packaging together with the protective gas, then it can be ensured that an especially even distribution of the aerosol in the head space of the packaging can be achieved. This can lead among other things to improve shelf life, an improved, more constant scent and/or improved maintenance of the color of the food product.

Simple process conditions can be enabled when the fluid is atomized in the protective gas into an aerosol. This aerosol can then be added among other things in a simple manner to the protective gas to be introduced or added in any other way in order to thereafter jointly introduce them into the head space of the packaging.

For the purpose of flavor-treating it has proven to be especially advantageous to use a mixture of a food-compatible fluid which comprises water, at least one flavoring agent and an antioxidant, a protective gas especially carbon dioxide, nitrogen or inert gas and mixtures thereof, and to spray this mixture into the head space of the foodstuff packaging.

It is further the object of the invention to provide an apparatus for performing the method in accordance with the invention which in a comparatively cost-effective way and with simple construction enables an introduction of agents for the flavor-treating of a foodstuff provided in the packaging.

This object is achieved by the invention with respect to the apparatus in such a way that the fluid storage container comprises a fluid containing water, at least one flavoring agent and at least one antioxidant, with the gas conduit opening into the head space of the packaging being connected both with the gas storage container and with the fluid storage container for jointly introducing the fluid and the protective gas into the head space of the packaging.

Simplified constructional conditions can be provided when the fluid storage container comprises a fluid containing water, at least one flavoring agent and at least one antioxidant, but in this case it is then constructionally possible, based on a storage container, to take measures for treating the foodstuff to be packaged. That is why it is also possible to connect the gas conduit of the introducing means, which opens into the head space of the packaging in a constructionally simple way, both with the gas storage container and also with the fluid storage container for jointly introducing the fluid and the protective gas into the head space of the packaging, so that a simple apparatus for flavor-treating of a packaging can be provided. An evenly distributed aerosol can further be ensured in the head space of the packaging by jointly introducing the fluid and the protective gas.

If the fluid storage container is connected with the gas conduit via an aerosol container in which the fluid of the fluid storage container is atomized, the distribution of the aerosol over the foodstuff can be additionally improved in a constructionally simple way. The comparatively constant aerosol of the aerosol container can be added to the protective gas in a simple way, so that complex constructions of introducing means for misting the aerosol can be avoided.

Simple constructional conditions can further be created if the aerosol container comprises the protective gas of the gas storage container. Moreover, impurities of the introduction means can thereby be avoided in a simple way.

### BRIEF DESCRIPTION OF THE DRAWINGS

The subject matter of the invention is shown in the drawing by reference to several embodiments shown by way of example, wherein:

FIG. 1 shows a first embodiment and

FIG. 2 shows a second embodiment.

### DESCRIPTION OF THE PREFERRED EMBODIMENT

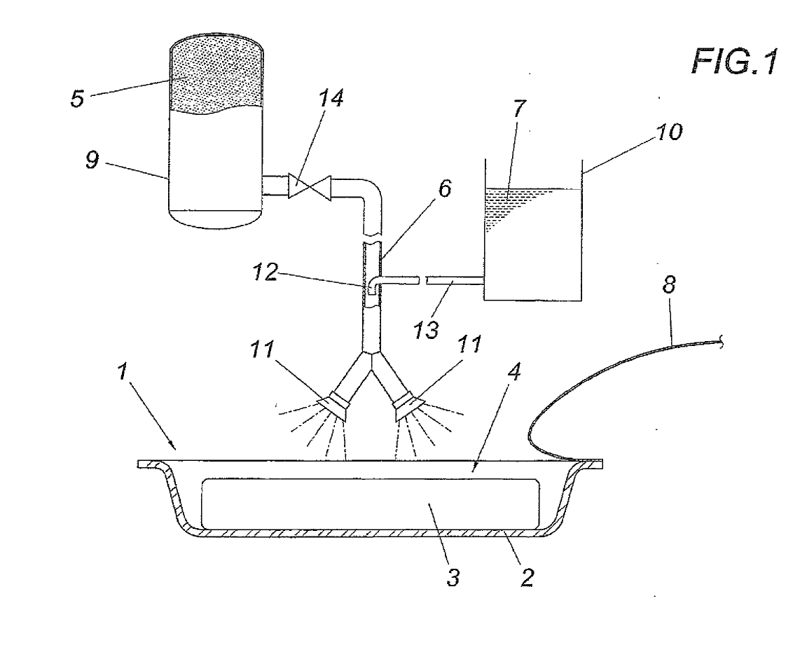

The apparatus shown in FIG. 1 by way of example as the first embodiment comprises a packaging 1 with a shell 2 made of plastic, which shell 2 accommodates a foodstuff and/or a food product 3 to be packaged. A protective gas 5 is introduced into the opened package 1 into its head space 4. A gas conduit 6 is provided for this purpose. A food-compatible fluid 7 is introduced into the head space 4 together with the protective gas 5, with the fluid 7 comprising a food-compatible flavoring agent. After the introduction of the fluid 7 and the protective gas 5, the packaging 1 is sealed in a gas-tight manner with a film 8. The protective gas 5 is provided in a gas storage container 9 for example, wherein the fluid 7 can be stored in a fluid storage container 10. The fluid 7 and the protective gas 5 are jointly conducted by the gas conduit 6 to the packaging 1. The method in accordance with the invention is especially characterized in that a food-compatible antioxidant is added to the fluid 7 which comprises water as the main constituent and the flavoring agent. An improved and more stable delivery of the scent of the flavoring agent can be achieved by the antioxidant upon opening the packaging 1 by removing the film 8 when the antioxidant is introduced as a constituent of the fluid 7 together with the protective gas 5, which fluid 7 further comprises the flavoring agent and water.

For the purpose of the improved distribution of the protective gas 5 comprising a fluid 7, these agents 5 and 7 are introduced by two nozzles 11 into the head space 4 of the packaging 1. As a result of the nozzles, the fluid 7 can be converted advantageously at least in part into an aerosol, thereby leading to a special distribution of the fluid plus the protective gas 5 in the head space 4 of the packaging 1 and to an improved shelf life of the scent. This formation of aerosols can already occur in part in the gas conduit 6 or can be performed where the gas conduit 6 conducting the protective gas 5 is supplied with fluid 7.

Moreover, the addition of the fluid 7 with the help of a vacuum bend 12 of the fluid conduit 13 protruding into the gas conduit 6 has proven to be advantageous concerning the distribution of the fluid 7 in the protective gas 5. The valve 14 can be used to set the quantity of supplied protective gas 5 and thereby also the supplied quantity of fluid 7.

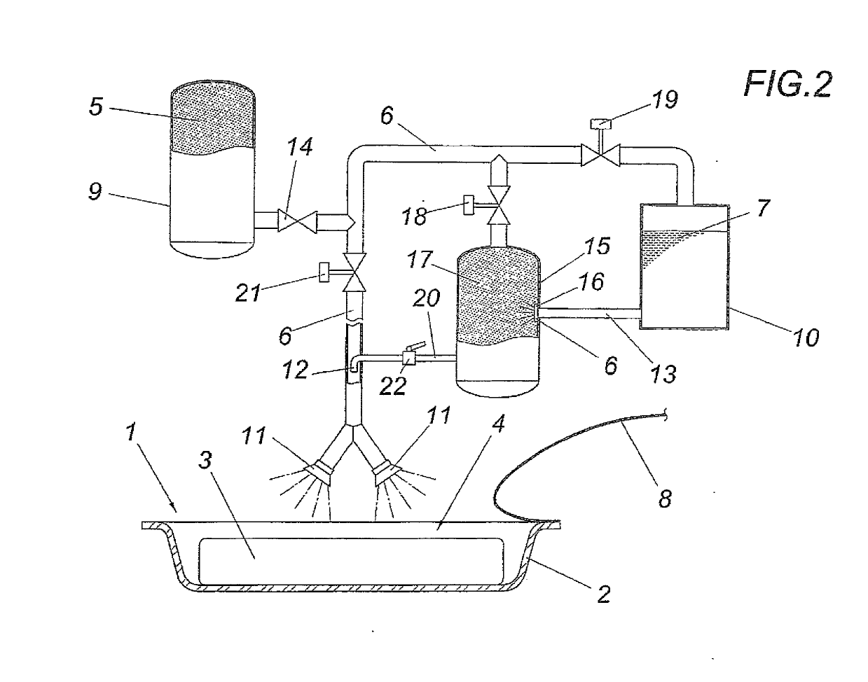

In accordance with the second embodiment as shown in FIG. 2, a modification in the atomizing of the fluid 7 is shown in contrast to the first embodiment as shown in FIG. 1. In this case, the fluid 7 of the fluid storage container 10 is conducted via a fluid conduit 13 to an atomizer nozzle 16 protruding into an aerosol container 15. Since the fluid storage container 10 is under pressure because it is connected for example to the pressurized gas conduit 6, the fluid 7 pressed into the aerosol container 15 is atomized. An aerosol 17 can be created in the aerosol container 15, which can lead to a special constancy in the distribution of the floating particles in the gas. Furthermore, increased concentrations of the atomized fluid 7 in the gas of the aerosol container 15 are also enabled in a simple manner. The aerosol container 15 is also simply filled with protective gas 5 of the gas container 9, in that the gas conduit 6 is connected with the aerosol containers 16 via an adjusting valve 18. In order to enable the setting of different pressure conditions between the fluid container 10 and the aerosol container 15, the fluid container 10 is connected via an adjusting valve 19 with the gas conduit 6.

The aerosol 17 of the aerosol container 10 is then supplied via a connecting conduit 20 to the gas conduit 6 conducting the protective gas 5, so that said aerosol 17 can be introduced jointly with the protective gas 5 into the head space 4 of the packaging 1. The aerosol 17 can then mix with the protective gas 5 and/or be added to this flow in an unmixed manner. The nozzles 11 may optionally be omitted by the previously occurring generation of aerosol in the aerosol container 15, although a final common nozzle may certainly promote a more even distribution in the head space 4 of the packaging 1.

A further adjusting valve 21 is further provided in the gas conduit 6 in order to enable the control of the joining of protective gas 5 and aerosol 17 according to the pressure conditions in the gas container 9, with a quantity valve 22 being provided in the connecting conduit 20 for controlling the volume of aerosol 17.

1. A method for flavor-treating a food product (3) provided in a packaging (1), in which a protective gas (5), especially carbon dioxide, nitrogen, inert gas or mixtures thereof, is introduced into the head space (4) of the open packaging (1) together with a fluid (7) comprising at least one flavoring agent before the packaging (1) is sealed in a gas-tight manner, wherein an antioxidant is added to the fluid (7) with the flavoring agent, which fluid especially comprises water as the main constituent.

2. A method according to claim 1, wherein the fluid (7) comprises a flavoring essence as the flavoring agent.

3. A method according to claim 1, wherein the fluid (7) is added to the protective gas (5) by means of negative pressure.

4. A method according to claim 1, wherein the protective gas (5) is sprayed together with the fluid (7) into the head space (4) of the packaging (1).

5. A method according to claim 1, wherein the quantities of flavoring agent lie in the range of 0.1 to 3% by weight and of antioxidants in the range of 0.1 to 10% by weight on the basis of the weight of the fluid (7).

6. A method according to claim 1, wherein the fluid (7) is atomized into an aerosol (17) before it is introduced into the packaging (1) together with the protective gas (5).

7. A method according to claim 6, wherein the fluid (7) is atomized in the protective gas (5) into an aerosol (17).

8. The use of a mixture of a fluid (7), which comprises water, at least one flavoring agent and an antioxidant, and of a protective gas (5), especially carbon dioxide, nitrogen, inert gas or mixtures thereof, for spraying into the head space (4) of a packaging (1) for flavor-treating a food product (3) provided in the packaging (1).

9. An apparatus for flavor-treating a food product (3), comprising a food product (3) provided in the packaging (1), a fluid storage container (10) which comprises a fluid (7) containing a flavoring agent, a gas storage container (9) for a protective gas (5), especially carbon dioxide, nitrogen, inert gas or mixtures thereof, and at least one introduction means comprising a gas conduit (6) for introducing the flavoring agent and the protective gas (5) into the head space (4) of the packaging (1), wherein the fluid storage container (10) comprises a fluid (7) containing water, at least one flavoring agent and at least one antioxidant, with the gas conduit (6) opening into the head space (4) of the packaging (1) being connected both with the gas storage container (9) and also with the fluid storage container (10) for joint introduction of the fluid (7) and the protective gas (5) into the head space (4) of the packaging (1).

10. An apparatus according to claim 9, wherein the fluid storage container (10) is connected with the gas conduit (6) via an aerosol container (15) in which the fluid (7) of the fluid storage container (10) is atomized.

11. An apparatus according to claim 10, wherein the aerosol container (15) comprises protective gas (5) of the gas storage container.
